(19) United States
(12) Patent Application Publication
(10) Pub. No.: US 2026/0115093 A1
(43) Pub. Date: Apr. 30, 2026

(54) Ultrasonic Cavitation Nasal Clip Device for Therapy with Built-in Medication Supply Soaked in Medicinal Liquid

(71) Applicant: Zhijun Peng, Foshan (CN)

(72) Inventor: Zhijun Peng, Foshan (CN)

(21) Appl. No.: 19/000,527

(22) Filed: Dec. 23, 2024

(30) Foreign Application Priority Data
Oct. 30, 2024 (CN) 202411529489.1

(51) Int. Cl. A61H 23/02

(52) U.S. Cl. CPC A61H 23/0245; A61H 2201/0153; A61H 2201/0157; A61H 2201/105; A61H 2201/1207; A61H 2201/1607; A61H 2201/165; A61H 2201/5097; A61H 2205/023

(57) ABSTRACT

An ultrasonic cavitation nasal clip device for therapy with built-in medication supply soaked in medicinal liquid comprises a U-shaped elastic component, as well as a left clip block and a right clip block respectively connected to both ends of the U-shaped elastic component. Each of the left clip block and the right clip block is provided with an ultrasonic therapy unit. The invention is characterized in that each of the left clip block and the right clip block is respectively provided with a medicinal-liquid chamber and a cavity. On the side surface of each clip block, a medicinal liquid outlet hole is formed in communication with the medicinal-liquid chamber. A cotton pad soaked in medicinal liquid is installed in the medicinal-liquid chamber, which is further equipped with a sealable lid that can be repeatedly opened or closed.

### FIELD OF THE INVENTION

This invention relates to the field of human ultrasonic therapy instruments, in particular to an ultrasonic therapy nasal clip device.

### BACKGROUND OF THE INVENTION

At present, in the research field of otolaryngology, doctors and experts are well aware that long-term massage of the nose can relieve and suppress the occurrence of various chronic nasal diseases. For example, patients with nasal congestion caused by allergic rhinitis or the common cold can apply ginger juice on both sides of the nose and then gently massage by hand to help clear the nasal passages. People can improve and alleviate various uncomfortable symptoms of the nasal cavity by massaging the nose; nose massage has a calming effect that helps improve blood circulation in the nasal mucosa, promotes normal mucus secretion, strengthens disease resistance, prevents colds and rhinitis, keeps the nasal cavity moist at a normal temperature, increases cold tolerance, and enhances the sense of smell-thus providing beneficial therapeutic effects.

On Jul. 30, 2020, the applicant filed a patent application with the China National Intellectual Property Administration (CNIPA) under the application No. 202021552597.8, published as CN212347130U, entitled “An Ultrasonic Cavitation Blood Massage Nasal Clip Device.” This previous solution primarily includes a U-shaped elastic component, and a left clip block and a right clip block connected to both ends of the U-shaped elastic component. An inner cavity is provided in the left clip block and the right clip block; a medication delivery interface connected to the inner cavity and a medication spray hole for spraying medicinal mist outward are provided on the outer surfaces of the left and right clip blocks; and an ultrasonic therapy unit is additionally provided inside the inner cavity. In use, it can spray medicinal mist on the nose area while using the ultrasonic therapy unit to output high-frequency ultrasonic vibration massage. Compared to traditional manual massage, this greatly improves therapeutic efficacy and efficiency. However, after a period of use, it was found that the previous solution still has some drawbacks:

It requires a separate electrical medication-supply host device, connected to the medication supply mechanism and the medication delivery interface by a soft tube, and the ultrasonic therapy unit needs control signals and power from this host device. As a result, tubing and wiring restrain the nasal clip device and the host, making it very inconvenient to use-one cannot wear it while working, thereby affecting its portability.

The ultrasonic therapy unit and the spray function share one closed inner cavity. Because the ultrasonic therapy unit is placed in a humid environment, its safety and lifespan are easily compromised. Meanwhile, since the inner cavity is relatively closed, any medicinal liquid adhering to it cannot be promptly cleaned, thereby forming hygienic blind spots that breed bacteria and affect health and safety.

Consequently, the applicant believes the foregoing nose massage product still has many shortcomings, and it is highly necessary to redesign and develop it to better serve people's health.

### SUMMARY OF THE INVENTION

The object of the present invention is to address the foregoing problems and disadvantages by providing an ultrasonic cavitation nasal clip device for therapy with built-in medication supply soaked in medicinal liquid. By incorporating a built-in medication supply mechanism that is separate from and integrated with the ultrasonic therapy unit, the ultrasonic therapy unit can be conveniently detached. This allows components such as the U-shaped elastic component, the left clip block, and the right clip block to be cleaned with water, thereby resolving cleaning and hygiene issues. It also protects the ultrasonic therapy unit from medicinal fluid corrosion, extending the unit's service life. Furthermore, by providing replaceable medicinal pads soaked in medication, the invention meets the requirement that the U-shaped elastic component, the left clip block, and the right clip block, etc., can be reused, while also allowing the user to replace pads containing different active substances to meet different therapeutic needs, achieving simple and convenient operation.

This invention is realized through the following technical solution: An ultrasonic cavitation nasal clip device for therapy with built-in medication supply soaked in medicinal liquid, which includes a U-shaped elastic component and a left clip block and a right clip block connected to both ends of the U-shaped elastic component. Ultrasonic therapy units are respectively provided on the left and right clip blocks. The invention is characterized in that the left and right clip blocks are respectively provided with a medicinal-liquid chamber and a cavity; a medicinal liquid outlet hole communicating with the medicinal-liquid chamber is formed on the side of each clip block; a medicinal pad soaked in medication is installed in each medicinal-liquid chamber; and each medicinal-liquid chamber is further provided with a sealable lid that can be repeatedly opened and closed. Together, the sealable lid, the soaked medicinal pad, the medicinal-liquid chamber, and the medicinal liquid outlet hole form an integrally designed built-in medication supply mechanism. The ultrasonic therapy unit is detachably embedded in the cavity.

In a further embodiment, a first finger recess is additionally provided on each of the left and right clip blocks, adjacent to the sealable lid.

In another further embodiment, the left clip block and the right clip block are each provided with an outwardly extending portion, on which the cavity is formed.

In yet another embodiment, a cooperating protrusion and slot are provided between the ultrasonic therapy unit and the cavity to form a nested fit.

By adopting a built-in medication supply mechanism that is separate from and integrated with the ultrasonic therapy unit, the ultrasonic therapy unit can be conveniently removed, enabling the U-shaped elastic component, left clip block, and right clip block to be washed with water. This solves cleaning and hygiene issues and protects the ultrasonic therapy unit from corrosion by medicinal fluid, thereby extending the unit's service life. Meanwhile, the replaceable soaked medicinal pad design ensures that the U-shaped elastic component, left clip block, and right clip block can be reused, and also allows the product to use different types of medicinal pads for various therapeutic needs in a simple manner. Using high-frequency ultrasonic vibrations from the ultrasonic therapy unit not only disperses the medicinal fluid from the soaked pad, allowing it to flow through the medicinal liquid outlet hole onto the nose and nearby skin, but also causes the cells of the skin to move more rapidly, opening micro-pores to absorb the medicinal fluid and achieving targeted therapeutic effects. Additionally, the high-frequency vibrations from the ultrasonic therapy unit promote microcirculation in the capillaries of the nose and surrounding skin, improving blood flow and accelerating metabolism in those regions. Consequently, it provides therapeutic, rehabilitative, and health-preserving effects for the nose and adjacent skin, helping to repair lesions.

### BRIEF DESCRIPTION OF THE DRAWINGS

FIG. 1 is a three-dimensional schematic view of the nasal clip device of the present invention, showing a version equipped with a Velcro strap;

FIG. 2 is a schematic view of the structure when the soaked medicinal pad is removed according to the present invention;

FIG. 3 is a schematic view of the structure when the ultrasonic therapy unit is removed according to the present invention;

FIG. 4 is a partial structural schematic view illustrating the ultrasonic therapy unit removed from the outwardly extending portion according to the present invention;

FIG. 5 is a first exploded view of the ultrasonic therapy unit according to the present invention;

FIG. 6 is a second exploded view of the ultrasonic therapy unit according to the present invention;

FIG. 7 is a schematic diagram showing the ultrasonic therapy unit in use with a wireless charger according to the present invention;

FIG. 8 is a three-dimensional schematic view of the nasal clip device of the present invention using an elastic band.

### DETAILED DESCRIPTION OF THE EMBODIMENTS

As shown, the present invention provides an ultrasonic cavitation nasal clip device for therapy with built-in medication supply soaked in medicinal liquid, comprising a U-shaped elastic component (1) and a left clip block (2) and a right clip block (3) connected to both ends of the U-shaped elastic component (1). Ultrasonic therapy units (4) are respectively provided on the left clip block (2) and the right clip block (3).

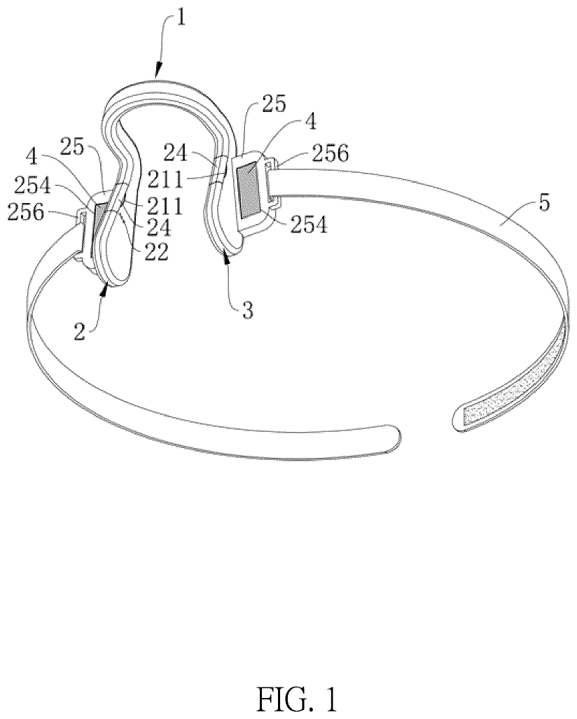

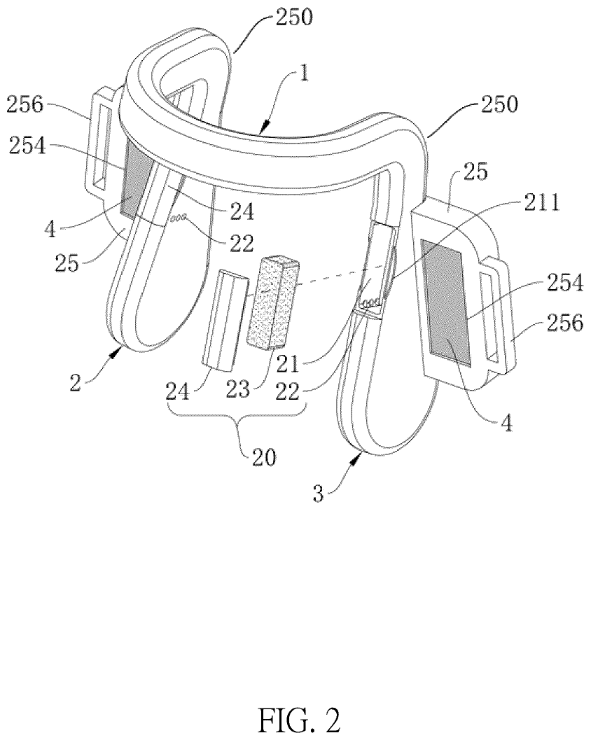

To achieve the above purpose of the invention, as shown in FIGS. 1 and 2, the left clip block (2) and the right clip block (3) are respectively provided with a medicinal-liquid chamber (21) and a cavity (251). On the side of the left clip block (2) and the right clip block (3), there is a medicinal liquid outlet hole (22) communicating with the medicinal-liquid chamber (21). Inside each medicinal-liquid chamber (21), a medicinal pad (23) soaked in medicinal fluid is installed. Additionally, each medicinal-liquid chamber (21) is provided with a sealable lid (24) that can be opened and closed repeatedly. Together, the sealable lid (24), the medicinal pad (23), the medicinal-liquid chamber (21), and the medicinal liquid outlet hole (22) form an integrally designed built-in medication supply mechanism (20). The ultrasonic therapy unit (4) is detachably embedded in the cavity (251).

In this product, the ultrasonic therapy unit (4) is kept separate and isolated from the medicinal-liquid chamber (21), preventing the medicinal fluid from corroding the ultrasonic therapy unit (4). Moreover, the ultrasonic therapy unit (4) is designed to be detachable, making it easy to clean the unit itself, ensuring that medicinal fluid does not adhere tightly to the ultrasonic therapy unit (4) and improving hygiene. Meanwhile, because the ultrasonic therapy unit (4) has a detachable design, the U-shaped elastic component (1), the left clip block (2), the right clip block (3), and so on, can be submerged in water for cleaning after use, effectively ensuring their hygiene. The medicinal pad (23) can be discarded after each use and replaced with a new one before the next use, thereby guaranteeing safety and cleanliness. Furthermore, thanks to this flexible method of replacing the soaked medicinal pad, multiple types of medicinal pads for different illnesses may be provided in a single product set by the manufacturer. Users can select pads with different medicinal effects according to the instructions, effectively meeting the user's needs. The medicinal pads (23) are typically cotton pads that have absorbed medicinal fluid derived from traditional Chinese medicine or Western medicine.

As shown in FIG. 2, a first finger recess (211) is respectively provided on the left clip block (2) and the right clip block (3), adjacent to the sealable lid (24). The user can easily open the sealable lid (24) by inserting a finger into the first finger recess (211).

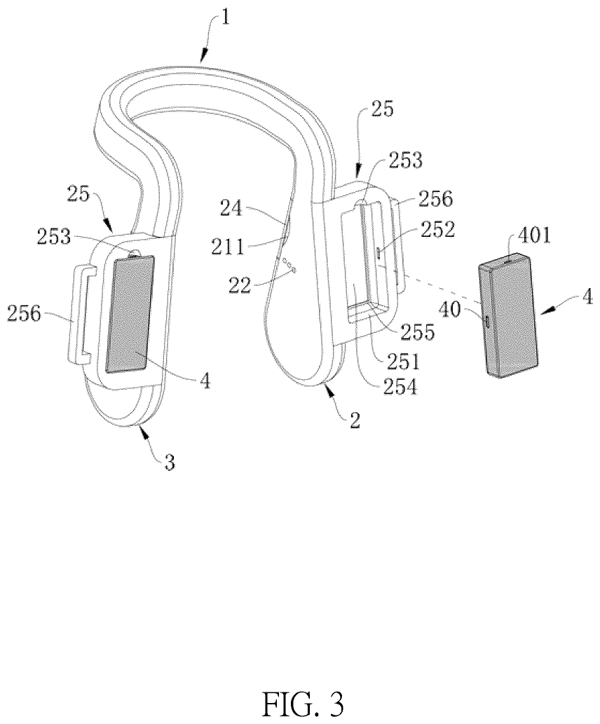

As shown in FIG. 3, the left clip block (2) and the right clip block (3) are each provided with an outwardly extending portion (25), on which the cavity (251) is formed. The ultrasonic therapy unit (4) is embedded in the cavity (251). By designing the outwardly extending portion (25), not only are the ultrasonic therapy unit (4) and the medicinal-liquid chamber (21) isolated from each other, but when the ultrasonic therapy unit (4) operates, it produces high-frequency ultrasonic vibrations that create resonance. Such resonance, in addition to massaging the nose at high frequency via the left clip block (2) and right clip block (3), also provides therapy and massage to the facial area around the nose, promoting blood circulation and metabolism in the face and providing eye-care benefits as well as relieving eye fatigue.

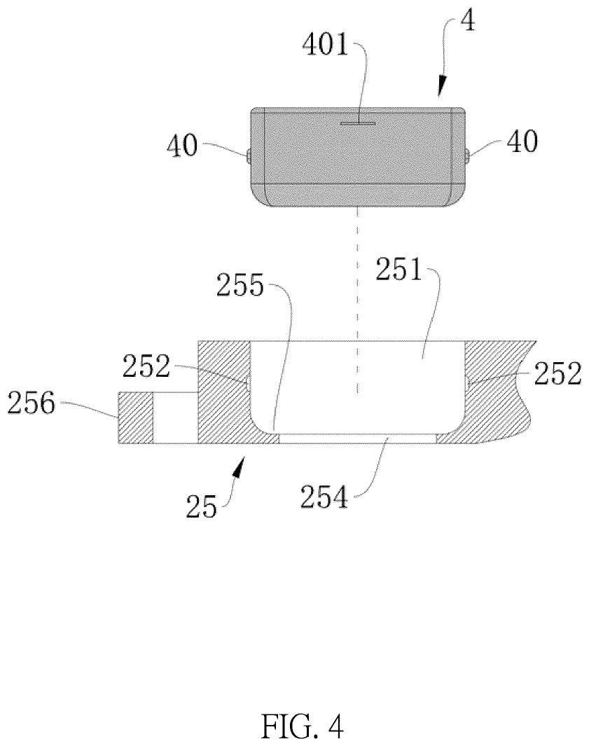

As shown in FIG. 4, a cooperating protrusion (40) and slot (252) that nest together are further provided between the ultrasonic therapy unit (4) and the cavity (251). Specifically, as shown in FIG. 4, the protrusion (40) is formed on the ultrasonic therapy unit (4), and the slot (252) is formed on the side wall of the cavity (251). Apart from the configuration shown in FIG. 4, the positions of the protrusion (40) and the slot (252) can also be interchanged. The protrusion (40) and slot (252) fit together, securing the ultrasonic therapy unit (4) in the cavity (251) to prevent inadvertent detachment.

As shown in FIGS. 3 and 4, the outwardly extending portion (25) is further provided with a second finger recess (253) adjacent to the cavity (251). Correspondingly, a finger grip (401) is provided on the ultrasonic therapy unit (4). By means of the second finger recess (253) and the finger grip (401), the user can simply and conveniently pry the ultrasonic therapy unit (4) out of the cavity (251). Consequently, the ultrasonic therapy unit (4) can be easily mounted and removed.

As shown in FIGS. 3 and 4, a through-hole (254) communicating with the cavity (251) is also formed on the outwardly extending portion (25), and a limiting step (255) is formed between the through-hole (254) and the cavity (251). By relying on the limiting step (255), the protrusion (40) and slot (252) can be accurately positioned when they engage. On one hand, the through-hole (254) reduces the weight of the left clip block (2) and the right clip block (3), making the device lighter and more comfortable to wear; on the other hand, it reduces material usage and lowers manufacturing costs.

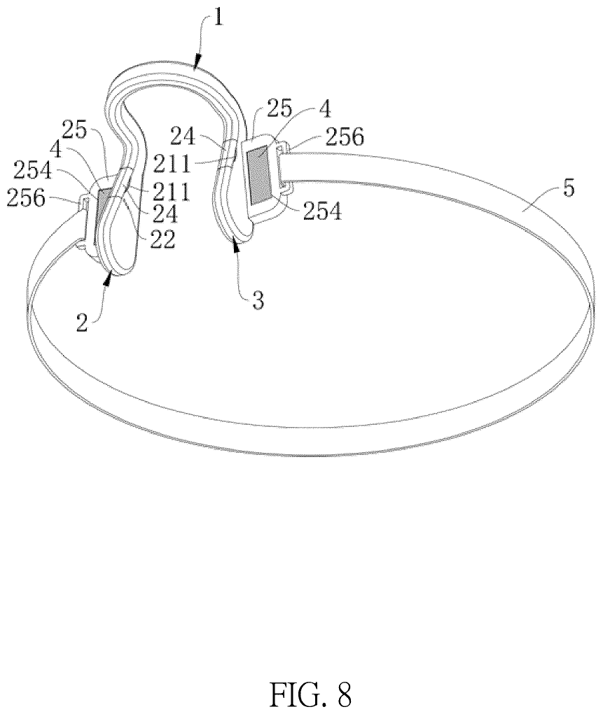

As shown in FIG. 1, the product may further include a strap (5). A ring-shaped protrusion (256) with a cord hole is formed on the outwardly extending portion (25) of the left clip block (2) and the right clip block (3). One end of the strap (5) is connected to the ring-shaped protrusion (256), while the other end is equipped with a tie section, typically designed with Velcro to simplify use. With the help of the strap (5), users can wear the product more securely, avoiding accidental dropping. Besides the arrangement shown in FIG. 1, the strap (5) can also be implemented using an elastic band, as shown in FIG. 8.

As shown in FIG. 2, an arched transition section (250) is arranged between the U-shaped elastic component (1) and the left clip block (2) and right clip block (3). This arched transition section (250) causes the U-shaped elastic component (1) to bow outward; when worn, it adapts precisely to the shape of the nasal bridge, functioning similarly to the nose bridge rest on eyeglasses.

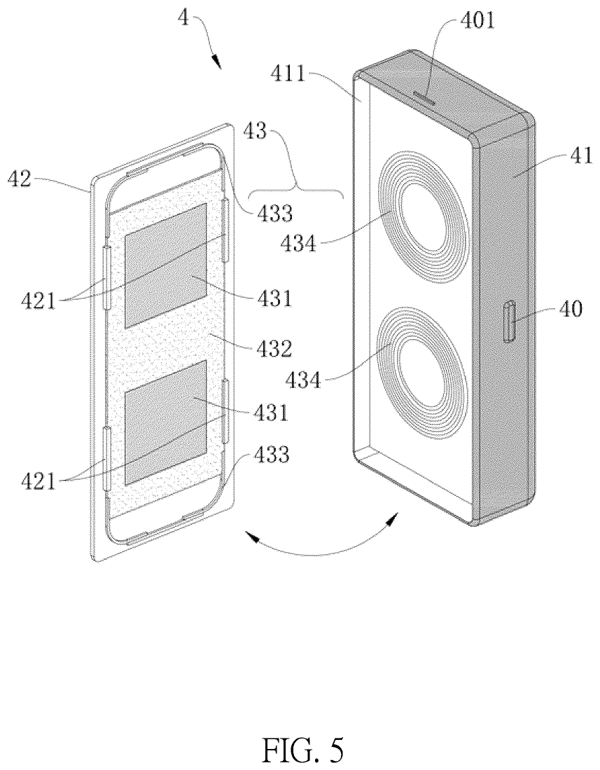

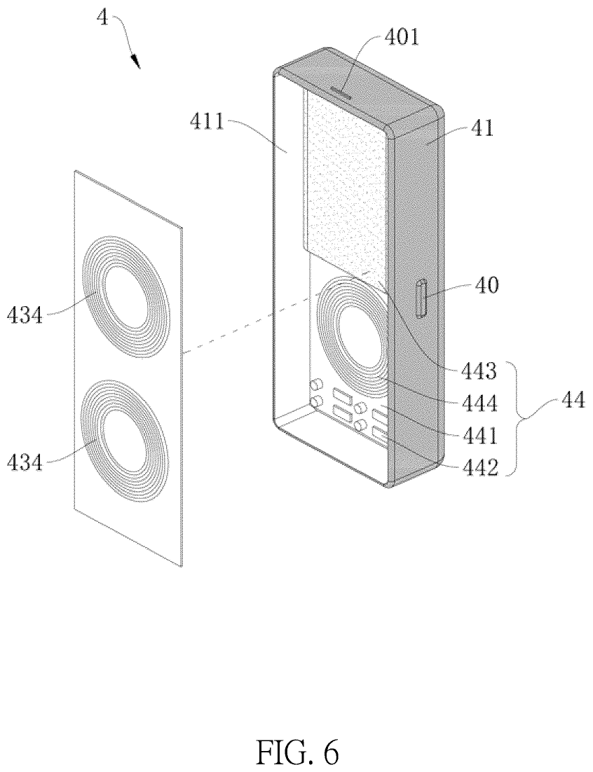

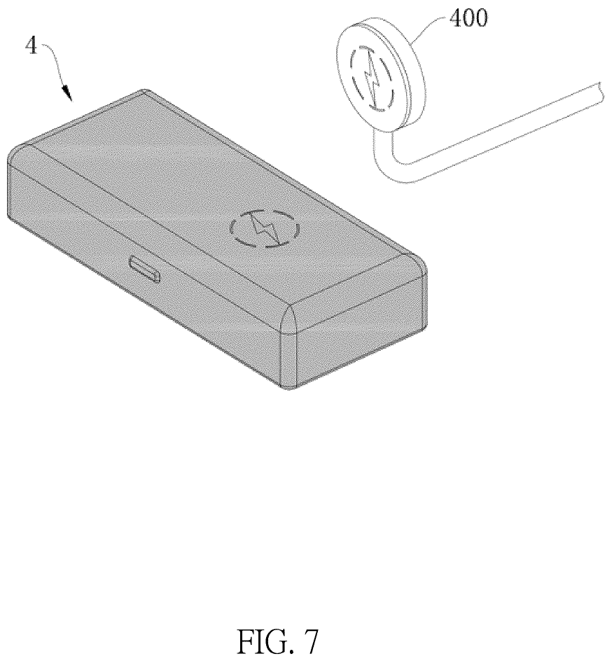

As shown in FIGS. 5 and 6, the ultrasonic therapy unit (4) includes a bottom shell (41) and a shell cover (42) that, when assembled, form a receiving cavity (411). An ultrasonic vibration assembly (43) and a drive control assembly (44) are arranged in the receiving cavity (411). The ultrasonic vibration assembly (43) comprises a sliding block (432) with a permanent magnet (431), elastic pieces (433) at both ends of the sliding block (432) that serve as buffers and return springs, and a drive coil (434) that cooperates with the permanent magnet (431) to produce a magnetic driving force. The drive control assembly (44) includes a circuit board (441) with a wireless communication module (442), a battery (443) in electrical connection with the circuit board (441), and a wireless charging coil (444). The drive coil (434) is electrically connected to the circuit board (441) to drive the ultrasonic vibration assembly (43). When the sliding block (432) with the permanent magnet (431) moves under the force from the drive coil (434), the elastic pieces (433) provide a counteracting force, returning the sliding block (432) to its initial position, thus achieving a back-and-forth motion. By providing a wireless charging coil (444), the ultrasonic therapy unit (4) supports wireless charging for added convenience. As shown in FIG. 7, the ultrasonic therapy unit (4) may undergo wireless charging via a wireless charging transmitter (400). With the wireless communication module (442), the ultrasonic therapy unit (4) can be connected to the Internet, enabling users to operate it remotely via a computer or smartphone over a network. The wireless communication module (442) may be a Bluetooth module, a Wi-Fi module, or similar. Specifically, the sliding block (432) moves within the shell cover (42), which is furnished with a protruding portion (421) to prevent the sliding block (432) from detaching.

The battery (443) supplies current to the drive coil (434) via wires. When current flows through the drive coil (434), it generates a magnetic field that drives the permanent magnet (431) and the sliding block (432) to move back and forth at a very high frequency within the receiving cavity (411), thereby producing high-frequency vibrations. These high-frequency vibrations propagate through media such as air to form ultrasonic waves. Alternatively, the high-frequency ultrasonic vibration mechanism composed of the sliding block (432) with the permanent magnet (431), the elastic pieces (433), and the drive coil (434) may be realized using an ultrasonic transducer or an ultrasonic motor.

I claim:

1. An ultrasonic cavitation nasal clip device for therapy with built-in medication supply soaked in medicinal liquid, comprising:
a U-shaped elastic component (1),
and a left clip block (2) and a right clip block (3) respectively connected to both ends of the U-shaped elastic component (1),
wherein each of the left clip block (2) and the right clip block (3) is provided with an ultrasonic therapy unit (4),
and each of the left clip block (2) and the right clip block (3) is respectively provided with a medicinal-liquid chamber (21) and a cavity (251),
a medicinal liquid outlet hole (22) communicated with the medicinal-liquid chamber (21) is formed on a side surface of each of the left clip block (2) and the right clip block (3),
and a medicinal pad (23) soaked in medicinal fluid is installed in each medicinal-liquid chamber (21),
each medicinal-liquid chamber (21) is additionally provided with a sealable lid (24) that can be repeatedly opened or closed,
the sealable lid (24), the medicinal pad (23), the medicinal-liquid chamber (21), and the medicinal liquid outlet hole (22) form an integrally built-in medication supply mechanism (20),
and the ultrasonic therapy unit (4) is detachably embedded in the cavity (251).

2. The ultrasonic cavitation nasal clip device for therapy with built-in medication supply soaked in medicinal liquid according to claim 1, wherein a first finger recess (211) is respectively provided on each of the left clip block (2) and the right clip block (3), adjacent to the sealable lid (24).

3. The ultrasonic cavitation nasal clip device for therapy with built-in medication supply soaked in medicinal liquid according to claim 1, wherein an outwardly extending portion (25) is further provided on each of the left clip block (2) and the right clip block (3), and the cavity (251) is formed on the outwardly extending portion (25).

4. The ultrasonic cavitation nasal clip device for therapy with built-in medication supply soaked in medicinal liquid according to claim 3, wherein a cooperating protrusion (40) and slot (252) that fit together in a nested manner is provided between the ultrasonic therapy unit (4) and the cavity (251).

5. The ultrasonic cavitation nasal clip device for therapy with built-in medication supply soaked in medicinal liquid according to claim 3, wherein a second finger recess (253) is provided on the outwardly extending portion (25) adjacent to the cavity (251), and a finger grip (401) is formed on the ultrasonic therapy unit (4).

6. The ultrasonic cavitation nasal clip device for therapy with built-in medication supply soaked in medicinal liquid according to claim 3, wherein a through-hole (254) communicating with the cavity (251) is additionally formed on the outwardly extending portion (25), and a limiting step (255) is formed between the through-hole (254) and the cavity (251).

7. The ultrasonic cavitation nasal clip device for therapy with built-in medication supply soaked in medicinal liquid according to claim 3, further comprising a strap (5), wherein each of the outwardly extending portions (25) on the left clip block (2) and the right clip block (3) is provided with a ring-shaped protrusion (256), one end of the strap (5) is connected to the ring-shaped protrusion (256), and a tie section is formed on the other end of the strap (5).

8. The ultrasonic cavitation nasal clip device for therapy with built-in medication supply soaked in medicinal liquid according to claim 1, wherein an arched transition section (250) is provided between the U-shaped elastic component (1) and the left clip block (2) and right clip block (3).

9. The ultrasonic cavitation nasal clip device for therapy with built-in medication supply soaked in medicinal liquid according to claim 1, wherein the ultrasonic therapy unit (4) comprises a bottom shell (41) and a shell cover (42) that are assembled together and define a receiving cavity (411), and an ultrasonic vibration assembly (43) and a drive control assembly (44) arranged in the receiving cavity (411); the ultrasonic vibration assembly (43) includes a sliding block (432) with a permanent magnet (431), elastic pieces (433) at both ends of the sliding block (432) that provide buffering and return action, and a drive coil (434) cooperating with the permanent magnet (431) to generate magnetic driving force; the drive control assembly (44) includes a circuit board (441) provided with a wireless communication module (442), a battery (443) electrically connected to the circuit board (441), and a wireless charging coil (444); the drive coil (434) is electrically connected to the circuit board (441) so as to drive the ultrasonic vibration assembly (43).
